(19) United States
(12) Patent Application Publication
(10) Pub. No.: US 2016/0328983 A1
(43) Pub. Date: Nov. 10, 2016

(54) NAVIGATION AND COLLISSION AVOIDANCE SYSTEMS FOR UNMANNED AIRCRAFT SYSTEMS

(71) Applicants: Kelvin H. Hutchinson, Allora (AU); Nigel C. Andrews, Killarney (AU)

(72) Inventors: Kelvin H. Hutchinson, Allora (AU); Nigel C. Andrews, Killarney (AU)

(21) Appl. No.: 14/698,734

(22) Filed: Apr. 28, 2015

Related U.S. Application Data
(60) Provisional application No. 62/092,216, filed on Dec. 15, 2014.

(51) Int. Cl. G08G 5/04; G08G 5/00; G05D 1/00; G05D 1/02; G01C 21/00; G05D 1/10

(52) U.S. Cl. CPC G08G 5/045; G01C 21/005; G05D 1/101; G05D 1/0088; G05D 1/0202; G08G 5/0069; G05D 1/0022

(57) ABSTRACT

Systems and methods are disclosed that are used to navigate unmanned aircraft, and to facilitate the execution of collision avoidance maneuvers with such unmanned aircraft. The systems are embodied in the unmanned aircraft and a ground control station that is configured to communicate with and control the unmanned aircraft. The unmanned aircraft includes multiple types of sensors, to detect and monitor the location of potential airspace obstructions. In addition, the unmanned aircraft and ground control station include voice communication systems, which enable ground control operators to communicate with oncoming third party aircraft through the unmanned aircraft.

### CROSS-REFERENCE TO RELATED APPLICATIONS

This application is a non-provisional of, and claims priority to, U.S. provisional patent application Ser. No. 62/092,216, filed Dec. 15, 2014.

### FIELD OF THE INVENTION

The field of the present invention relates to unmanned aircraft systems. More particularly, the field of the present invention relates to navigation and collision avoidance systems for unmanned aircraft systems.

### BACKGROUND OF THE INVENTION

Unmanned Aircraft Systems (“UAS”) are increasingly being deployed in commercial and military applications. It is sometimes desirable to operate a UAS within national airspace (or in other locations that are frequented by commercial or other non-military aircraft). At those times, a UAS may operate beyond the sight of personnel within the ground control station (“GCS”), thereby hindering an operator's ability to visually navigate around and avoid collisions with obstructions. In addition, such airspace may be governed by various laws and agencies that promulgate regulations for maintaining safety (and avoiding collisions) within public airspace.

Accordingly, there is a growing need in the marketplace for new and improved communication, navigation, and control systems that may be used with UASs, which facilitate the operation of UASs in a legally-compliant manner (and also provide an effective means for avoiding collisions). Preferably, the new and improved communication, navigation, and control systems will be configured to operate the UASs, even when the UASs are not within visual sight of the GCS.

As the following will demonstrate, the systems and methods of the present invention address these needs in the marketplace (along with many others).

### SUMMARY OF THE INVENTION

According to certain aspects of the invention, a system for navigating an unmanned aircraft and avoiding collisions with airspace obstructions is provided. The system generally includes, in part, a surveillance system that is housed within and operated from an unmanned aircraft. The invention provides that the surveillance system is preferably configured to receive and broadcast

(1) automatic dependent surveillance broadcasts (ADS-B), (2) three-dimensional position information generated by a global positioning satellite (GPS) device along with a barometric sensor (using, for example, low power collision avoidance systems), and (3) position information generated from one or more transponders that are configured to communicate in modes S, A, and C. The invention provides that the surveillance system is configured to scan and detect obstructions within a defined area (airspace) from the unmanned aircraft.

According to such aspects of the invention, the unmanned aircraft will be equipped with a first central processing unit, which is configured to receive information from the surveillance system that detects and identifies a location of an obstruction within the defined area (airspace). The invention provides that the first central processing unit is further configured to determine whether an obstruction avoidance maneuver should be executed to avoid a collision with the obstruction—based on, e.g., the current location and flight path of the unmanned aircraft and the current location of the potential obstruction. The system further comprises flight control circuitry housed within the unmanned aircraft, which is configured to receive instructions from the first central processing unit and, if determined to be necessary or prudent, to direct the unmanned aircraft to execute an obstruction avoidance maneuver—and such obstruction maneuver may exhibit different forms, depending on the circumstances.

The system of the present invention further includes a ground control station (“GCS”). The GCS includes a second central processing unit, which is configured to communicate with the first central processing unit in the unmanned aircraft, via wireless communication modes. For example, the ground control station may be equipped with a tracking antenna for an industrial-scientific-medical (ISM) band digital transceiver, with the tracking antenna being connected to and communicating with the second central processing unit of the GCS. In addition, according to certain preferred embodiments, the GCS will be configured to track the current location of the unmanned aircraft—using automatic dependent surveillance broadcasts (ADS- B) that the GCS receives from the unmanned aircraft.

The system of the present invention further includes a database housed within the unmanned aircraft. The database is preferably configured to store and make accessible to the first central processing unit position information correlated to detected or known obstructions in the defined area (airspace). The invention provides that the detected or known obstructions in the defined area may consist of ground obstacles, airspace obstacles, special exclusion zones, or combinations of the foregoing. The invention provides that the position information correlated to detected or known obstructions preferably represents three-dimensional global positioning satellite (GPS) coordinates. The position information correlated to these obstructions may be provided to the database (housed within the unmanned aircraft) through a radio frequency (RF) communication link established between the unmanned aircraft and the GCS.

According to further preferred aspects of the present invention, the system includes a first digital voice system housed within the unmanned aircraft and a second digital voice system housed within the ground control station. The invention provides that the first digital voice system is configured to receive voice commands (audio content) from the second digital voice system, which are then transmitted from the unmanned aircraft through an airband transceiver, e.g., to a potential oncoming third party aircraft (obstruction). Similarly, the first digital voice system is further configured to receive incoming airband signals, e.g., from a potential oncoming aircraft (obstruction), and to transmit the incoming airband signals to the second digital voice system. This way, the GCS may be used to communicate with a potential oncoming aircraft (obstruction)—through the unmanned aircraft—such that an agreed upon collision avoidance maneuver may be executed with the potential oncoming aircraft (obstruction), through coordination between the GCS operator and the pilot of the third party aircraft. In such embodiments, the first digital voice system and second digital voice system may each comprise a 16-bit coder-decoder (CODEC), which is configured to receive analog audio content and convert the analog audio content into a digital signal (and to receive a digital signal and convert the digital signal into analog audio content for subsequent transmission).

In the event that two-way communication with an oncoming aircraft (obstruction) is not achieved, the first central processing unit will further be configured to determine whether an automatic and pre-defined obstruction avoidance maneuver should be executed to avoid a collision (as mentioned above and described further herein). Following the execution of the automatic and pre-defined obstruction avoidance maneuver, the first central processing unit is further configured to determine whether a second obstruction avoidance maneuver should be executed to avoid a collision with the obstruction, or if a holding pattern should be maintained, or if an original flight pattern may be resumed without the risk of collision.

The above-mentioned and additional features of the present invention are further illustrated in the Detailed Description contained herein.

### BRIEF DESCRIPTION OF THE FIGURES

FIG. 1 is a diagram showing the various components of the systems described herein, which are embodied within a UAS to control the navigation thereof and to avoid collisions with airspace obstructions.

FIG. 2 is a diagram showing the various components of the ground control systems described herein, which are configured to control the navigation of a UAS and to avoid collisions with airspace obstructions.

FIG. 3 is a diagram that summarizes the voice-to-digital conversion and communication process that may be executed by the ground control systems described herein.

FIG. 4 is a diagram that summarizes the voice communication (relay) process that may be executed by the UAS described herein.

FIG. 5 is a diagram that summarizes the process by which a UAS, when using the systems of the present invention, is configured to detect and communicate with potential airspace obstructions.

FIG. 6 is a diagram that summarizes the process by which the systems of the present invention detect portable collision avoidance systems (PCAS) traffic, which consist of mode A/C/S replies, and initiate the collision avoidance methods described herein.

FIG. 7 is a diagram that summarizes the process by which the systems of the present invention detect ADS-B/TABS traffic (which consist of DF17 ADS-B/TABS broadcasts from other aircraft), and initiate the collision avoidance methods described herein. DF17 is a type of message used for ADS-B/TABS position reporting, commonly referred to as download format DF 17.

FIG. 8 is a diagram that summarizes the process by which the systems of the present invention detect TABS-G (as defined herein) traffic, and initiate the collision avoidance methods described herein.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

According to certain preferred embodiments of the present invention, a system (and methods of use thereof) for navigating an unmanned aircraft system (“UAS”) and avoiding collisions with airspace obstructions is provided. In certain embodiments, the system includes a first central processing unit (housed within the UAS) that, along with certain autopilot circuitry, is configured to (1) control a flight path of the UAS; (2) receive data from a plurality of sensory devices (e.g., that are configured to receive mode A, C, and S, ADS-B/TABS and TABS-G broadcasts from other aircraft within a predefined area of the UAS); (3) store position, velocity, and altitude information, indicative of the location and trajectory of other aircrafts detected within a predefined area (airspace); (4) determine whether a collision avoidance maneuver should be executed to avoid colliding with such aircrafts; and (5) when necessary, issue instructions to the flight control circuitry autopilot to execute a collision avoidance maneuver (whereby such maneuver may exhibit one of multiple forms, depending on the circumstances, as described herein). As used herein, “TABS-G” means a traffic awareness beacon system-gliding, with collision avoidance capabilities. The TABS-G system will generate three-dimensional position information using a global positioning satellite (“GPS”) device combined with a barometric sensor (a commercially-available example of an TABS-G type of system is commonly known as a FLARM system). As used herein, “ADS-B/TABS” means an automated dependent surveillance-broadcast/traffic awareness beacon system—which, as mentioned above, detects DF17 broadcasts from other aircraft.

According to further preferred embodiments of the present invention, a ground control station (“GCS”) and the UAS will include systems for two-way communication and, furthermore, systems for communicating with potential inbound obstructions, namely, other third party aircraft. More specifically, the invention provides the voice communication systems provide the ability to remotely transmit voice communications to other third party aircraft through the UAS, whereby such voice communications are initiated remotely through the GCS via a digital high-speed wireless link. In such embodiments, communication via wireless modes consisting of either an ISM band transceiver, satellite modem, cellular telephone modem, or a dedicated radio frequency may be employed. The invention provides that the voice communication systems described herein represent a component of the collision avoidance systems encompassed by the present invention.

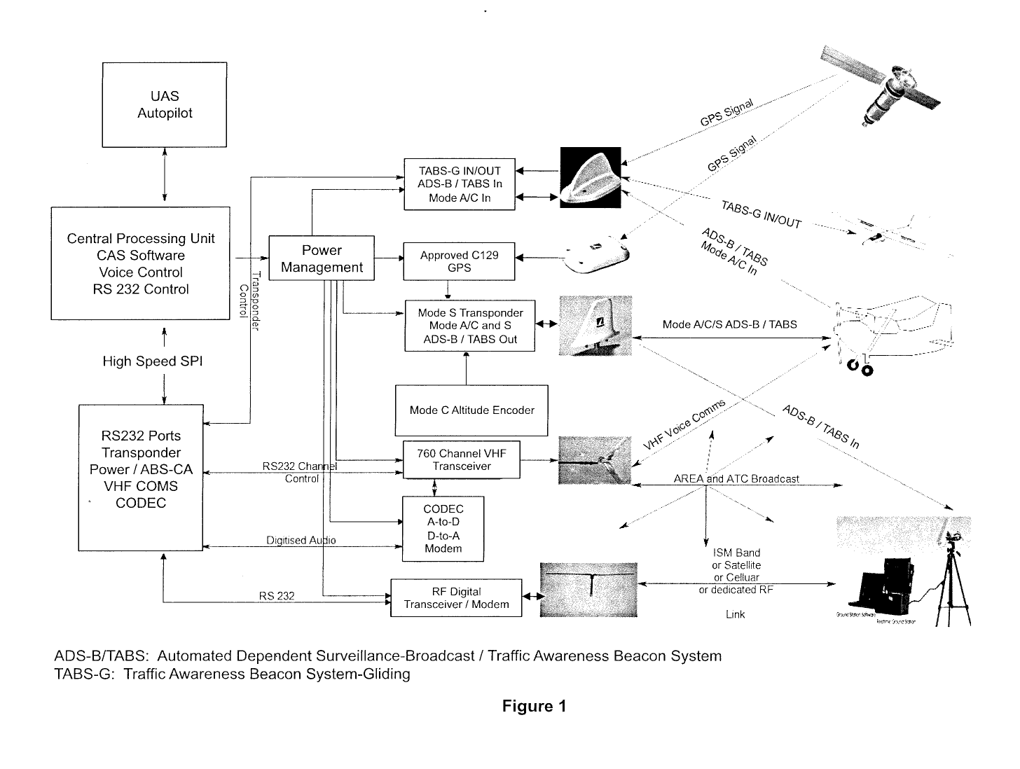

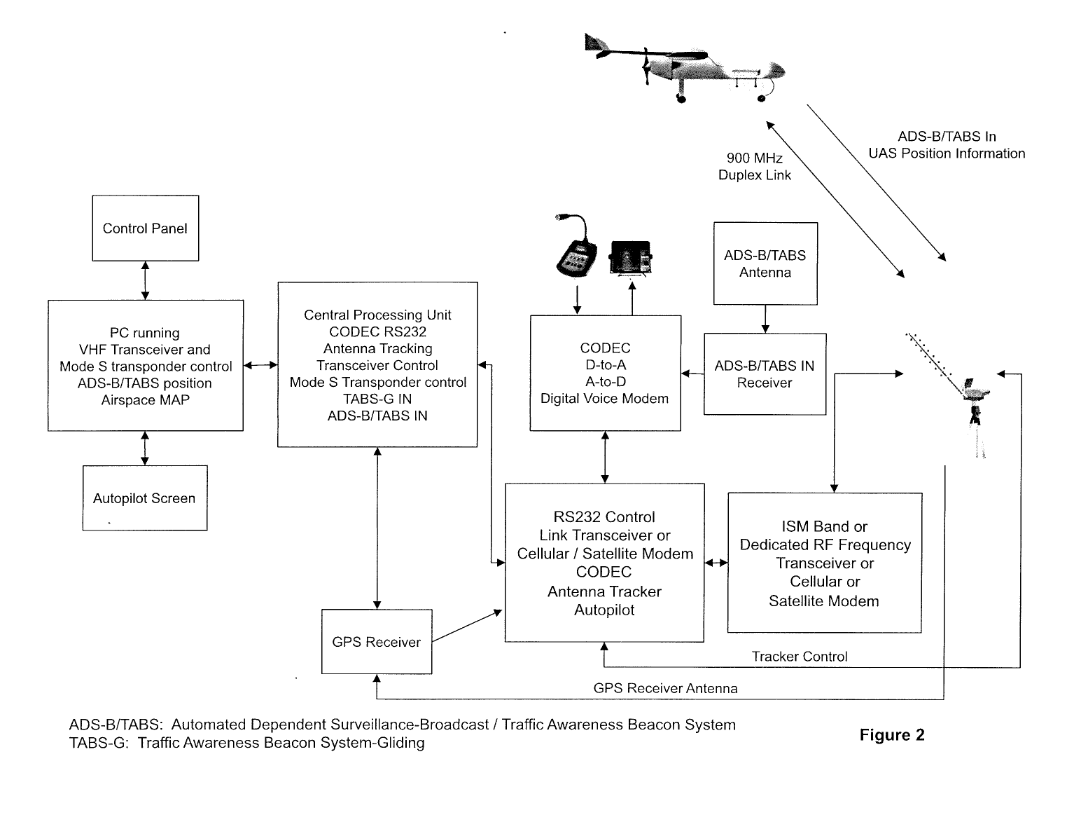

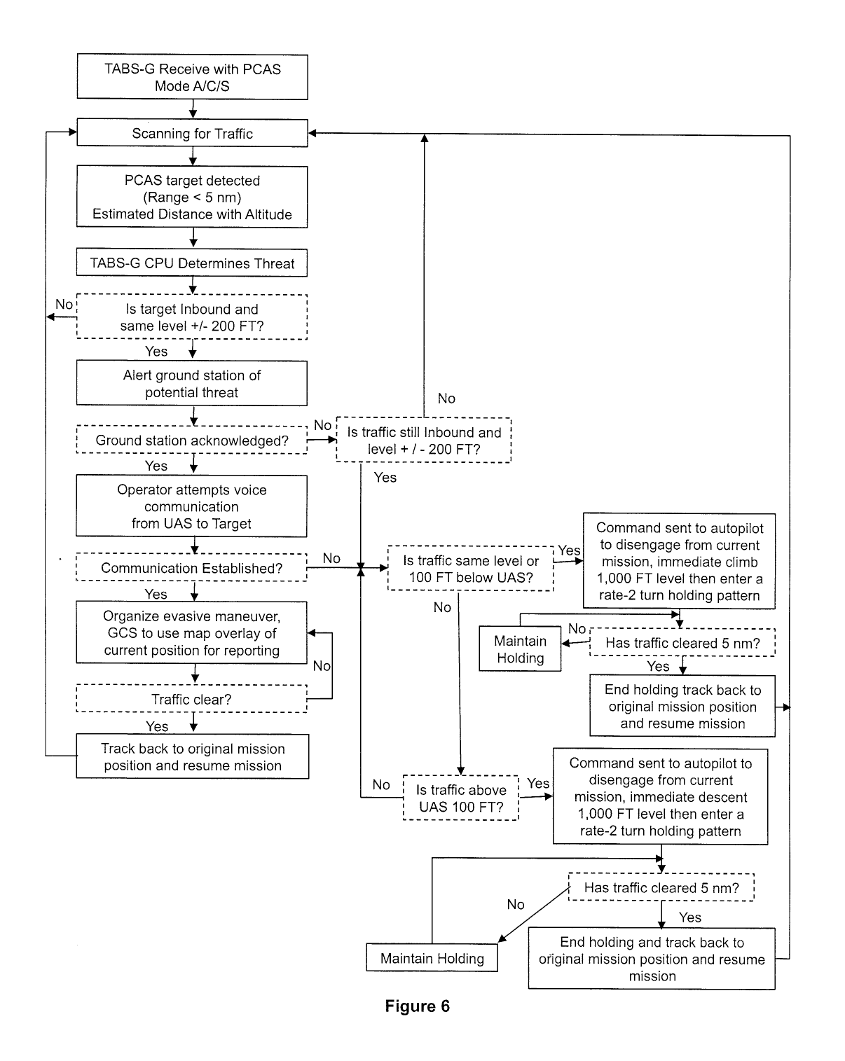

Referring now to FIG. 1, a diagram is provided showing the various components of the systems described herein, which are embodied within a UAS to control the navigation of the UAS and to avoid collisions with airspace obstructions. As shown in FIG. 1, the UAS will preferably include a plurality of aeronautical sensory devices, such as sensors that are (collectively) configured to detect mode A/C/S and ADS-B/TABS broadcasts, along with three-dimensional position information generated by a global positioning satellite (“GPS”) device combined with a barometric sensor (e.g., TABS-G sensors). The invention provides that these sensors are preferably connected serially to the first central processing unit (“CPU”) of the UAS. As further illustrated in FIG. 1, the CPU will preferably be configured to receive and process the information provided by these sensors—and control an autopilot circuitry should an obstruction threat be detected and, based on logic executed by the CPU (see, e.g., FIGS. 6-8), execute a collision avoidance maneuver to maintain a safe amount of separation with a potential obstruction. In addition, as illustrated and summarized in FIG. 2, the UAS and its CPU may be controlled by and communicate with a second CPU located within the GCS.

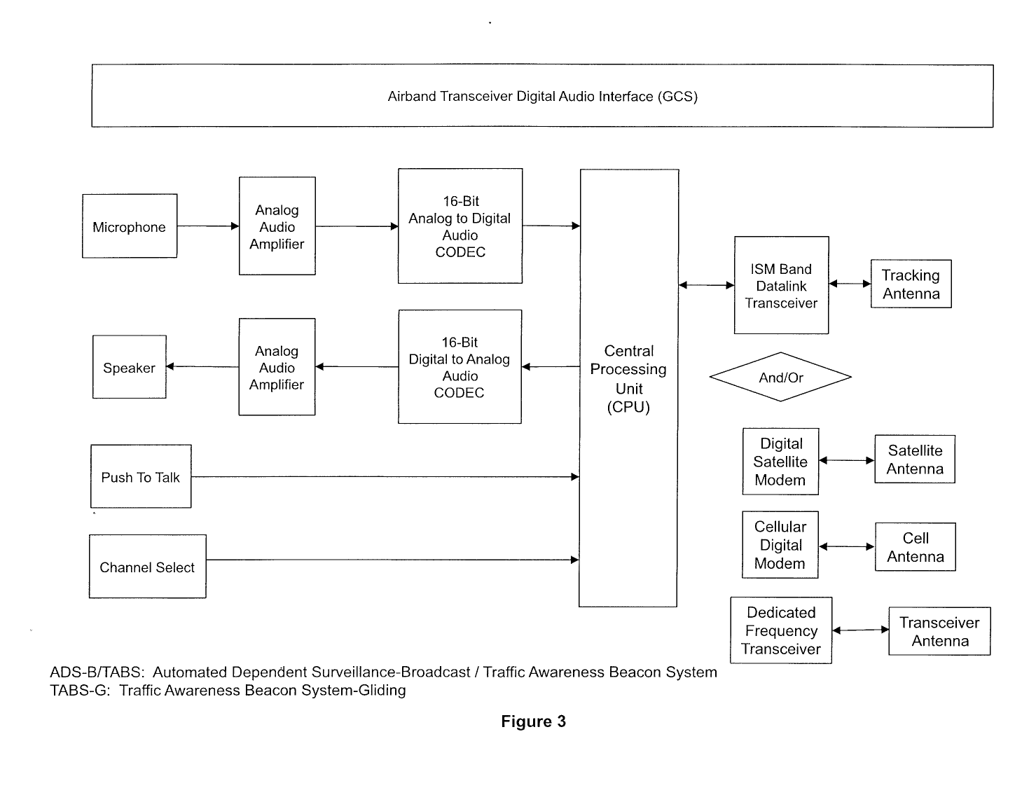

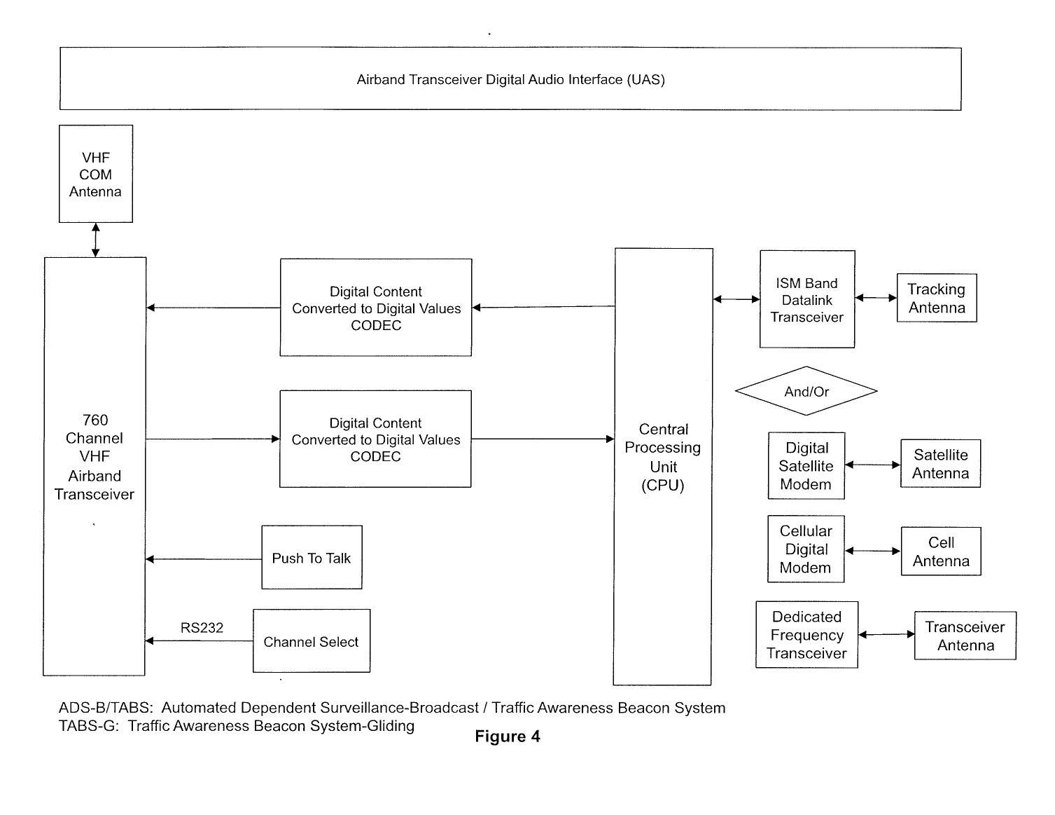

More specifically, in certain embodiments and as illustrated in FIGS. 1-5, an airband transceiver (located within the UAS), e.g., a 760-channel very high frequency (VHF) airband transceiver, will facilitate voice communication with oncoming third party aircraft. The invention provides that UAS transmissions are preferably broadcasted on, for example, ISM bands 828 to 925 MHz, depending on specific country regulations. The voice communication will be executed via digitized voice transmission and reception protocols that are executed by a “code-decode” (CODEC) digital voice conversion hardware component and related software (see FIGS. 3 and 4). The invention provides that the voice communications between the UAS and GCS will preferably be exchanged through ISM band transceivers, dedicated radio frequency (RF), 3G/4G cellular modems, or satellite modems. In such embodiments, as illustrated in FIGS. 2-4, low profile antennas (and others) are preferably employed to provide reception for GPS and reception/transmission for A/C/S and ADS-B/TABS transponders, TABS-G, and radio data links. In addition, the invention provides that the secondary surveillance radar (SSR) codes of the transponders may be modulated via a serial interface that is connected to the CPU of the UAS.

Referring now to FIG. 2, a diagram illustrating the various components of the GCS is provided. As shown, the GCS consists of its own (second) CPU that is configured to execute a voice CODEC module, for digitizing analog voice content which is then provided to a connected ISM band transceiver, satellite modem, cellular telephone modem, or a dedicated radio frequency. As shown in FIG. 2, the invention provides that the CPU is preferably connected to a personal computer (PC), which is used to display a very high frequency (VHF) airband transceiver status, control of frequency selection, volume and squelch parameters, and the current operation of the transponder, i.e., having an outbound mode A/C/S ADS-B/TABS, a class 1 or 2 technical standard order (TSO) device, with remote control facility (usually via RS232 or RS485 serial interface and text-based commands). In addition, the personal computer (operably coupled to the CPU of the GCS) will provide a rendering (display) of moving map information (an operations screen), showing the UAS centered on the map, along with flight data that include altitude, velocity, and directional information. The invention further provides that the display will include map data in the nature of flight information region (FIR) boundaries, restricted zones, airspace steps, and other relevant navigational information. In order to maintain signal integrity, the UAS is also monitored via a tracking control (antenna system) through the GCS. In such embodiments, and particularly when using ISM band or dedicated RF transceivers, the system will employ the use of directional antennas (controlled by Azimuth Zimuth (AZ) rotators), which are in turn controlled via the CPU/PC interface with information derived from the ADS-B feed that shows the UAS in real time.

Referring now to FIG. 3, a diagram is provided that summarizes the voice-to-digital conversion and communication process that may be executed by the GCS described herein. More particularly, as illustrated in FIG. 3, voice (audio) content spoken into a microphone is amplified and converted into digital content via a 16-bit analog-to-digital converter (ADC) within the CODEC module, such that the CPU may then further process and utilize the digital content. The invention provides that the voice (audio) content may be spoken into the microphone connected to the GCS after pressing a “push-to-talk” (PTT) button, which instructs the system that a voice communication will be forthcoming. In certain embodiments, the invention provides that the CPU will be configured to then transmit the digital (voice) content via an RF link (e.g., at a rate of 115 kbps or faster) to the UAS, for further processing and voice transmission out to any third party aircraft within reception range (airspace). Still further, the invention provides that audio content received by the GCS (back from the UAS), e.g., in-bound voice communications (digital content) that the UAS receives from third party aircraft, is received via an air link in digital packets, is processed within the CPU of the GCS, is converted from digital content into analog content (via the CODEC module), and is then amplified and presented through a loudspeaker to the GCS operators. The invention provides that the CPU will also be configured to process channel selection commands and volume/squelch control on the UAS radio.

Referring now to FIG. 4, a diagram is provided that summarizes the voice communication process that may be executed by the UAS described herein. More specifically, the invention provides that digital voice content (packets) will be received (from the GCS) via an RF link (e.g., an ISM band transceiver, dedicated RF frequency transceiver, satellite modem, or 3G/4G cellular modem) and transferred to the CPU of the UAS. The CPU will then connect to the CODEC modem, which then connects to an airband aviation transceiver (the CPU also connects the airband aviation transceiver radio dataport with the RF link)—whereupon the digital voice content (originating from the GCS) may then be retransmitted to third party aircraft. Similarly, the invention provides that the UAS will be configured to receive audio content (via the airband transceiver) from third party aircraft, whereupon the CODEC module and CPU will then transfer the audio content (received from third party aircraft) back to the GCS.

According to such embodiments, the CPU will preferably have a buffering capacity, such that if a portion of the audio content is lost, the CPU will may attempt to retrieve the lost audio content (i.e., any lost digital packets). The invention provides that a carrier detect function will be configured to confirm the expected digital packet length, so that the CPU can determine if a voice message is complete (with a checksum being delivered along with the digital packets, which must be received by the GCS). The invention provides that a broken communication link will result in the GCS and UAS being notified of the broken link, whereupon the CPU of the UAS may instruct the autopilot circuitry of the UAS to execute a holding flight pattern until the link is reestablished (and, if not reestablished, to abort the flight mission and return to a pre-defined base). Similarly, the invention provides that other commands (i.e., non-voice communications) received by the UAS must be acknowledged, so that any command issued to the transponder will be verified. The invention provides that an unverified command will result in the CPU resetting to the last known command, and for the GCS operator being advised (or, as mentioned above, in the case of a lost RF link, the UAS may be instructed to enter a holding flight pattern and, after a pre-determined period of time, if no RF link is reestablished, the UAS will automatically be instructed to abort its mission and return to a home base).

As mentioned above, the invention further provides that a push-to-talk (PTT) communication feature may be used to “key” the airband transceiver via the CPU, with the PTT line being active when in transmit mode. According to such embodiments, the UAS is preferably further configured to receive audio content, e.g., through the 760-channel airband transceiver, which is then transferred to the 16-bit CODEC module and the CPU for packet conversion, such that the content may then be relayed to the GCS via the RF link.

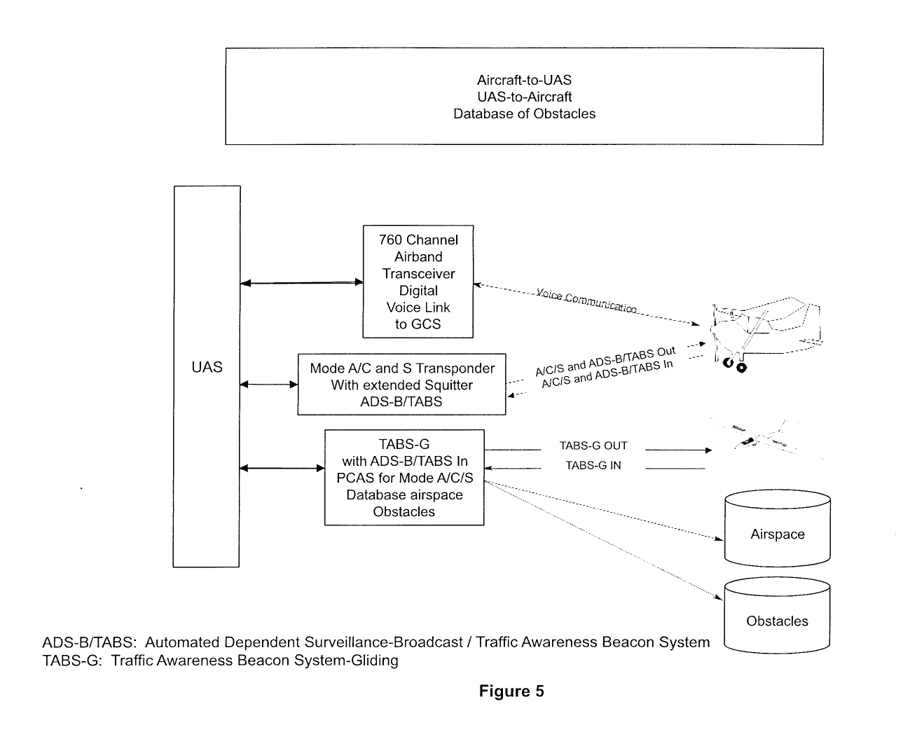

Referring now to FIG. 5, a generalized diagram is provided that summarizes the processes and systems used by a UAS to detect, communicate with, and avoid collisions with potential airspace obstructions (e.g., third party aircraft). As shown and described herein, the systems of the present invention enable the UAS (through the GCS) to communicate with third party aircraft and agree upon collision avoidance maneuvers with such third party aircraft (and, as discussed below and shown in FIGS. 6-8, the UAS may employ automatic collision avoidance maneuvers when coordinated communication with another aircraft is not possible or achieved).

The invention provides that a number of systems and processes are employed to achieve such collision avoidance functionality. More specifically, for example, the invention provides that a third party aircraft may be detected (and its proximity and distance from the UAS calculated based on) portable collision avoidance systems (PCAS) operating in mode A/C/S, i.e., the location of such aircraft will be calculated based on relative signal strength and known mode C altitude replies (for those aircraft replying to ground-based interrogations or other traffic collision avoidance system (TCAS) fitted aircraft). In addition, as illustrated in FIG. 5, the invention provides that the UAS will reply (through the GCS as described herein) to ground-based surveillance and TCAS-equipped aircraft (with mode A/C/S replies). The invention provides that the GCS will preferably be configured to adjust secondary surveillance radar (SSR) codes and set identifier data when requested via an air traffic controller (ATC) through the VHF airband transceiver described herein. The invention provides that the UAS will preferably be configured to issue either downlink format (DF)-17 or DF-18 extended squitter (ADS-B/TABS) broadcasts, which other aircraft and ground surveillance systems (which are capable of receiving ADS-B/TABS broadcasts) will receive. Similarly, third party aircraft equipped with TABS-G type systems (e.g., gliders, sports aircraft, and similar types of aircraft) will be able to communicate with the UAS through TABS-G systems. Still further, as illustrated in FIG. 5, the UAS will comprise an onboard database that contains location coordinates that inform the UAS of known obstacles within its proximate airspace. The CPU of the UAS will be configured to monitor the location of the UAS, relative to the surrounding known obstacles, based on the current GPS position coordinates of the UAS (and the known GPS coordinates of the known obstacles, as recorded within the onboard database).

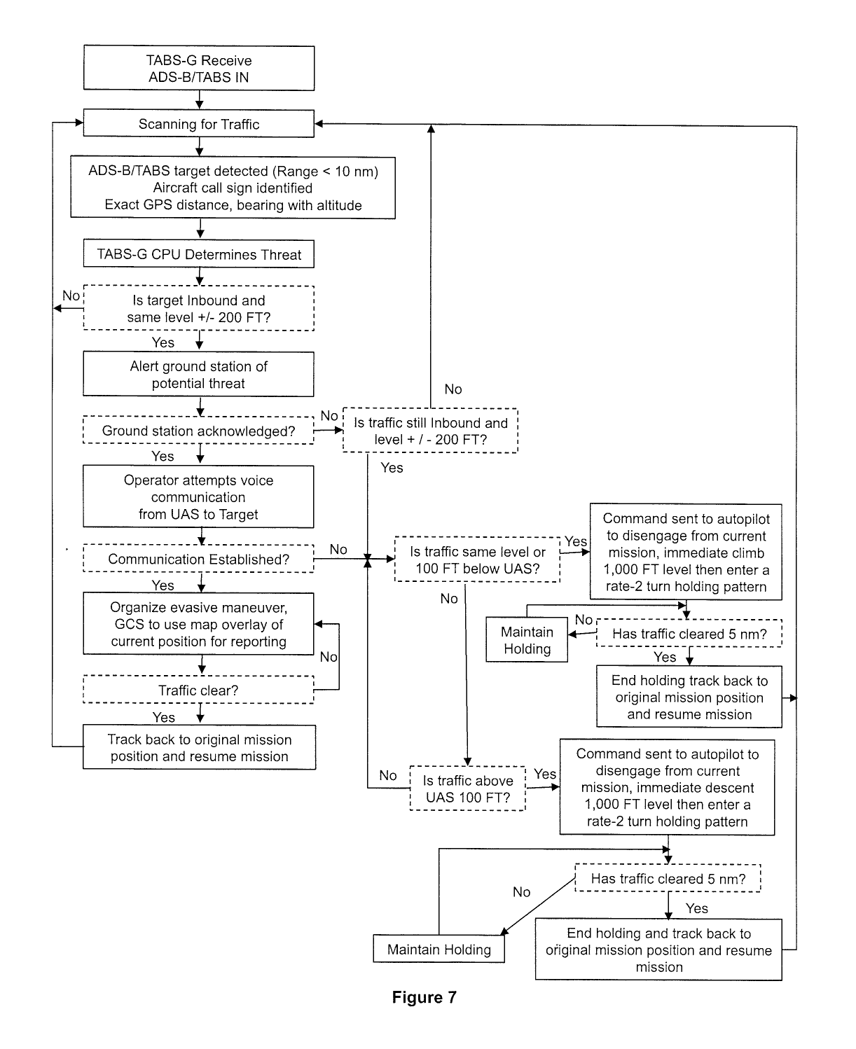

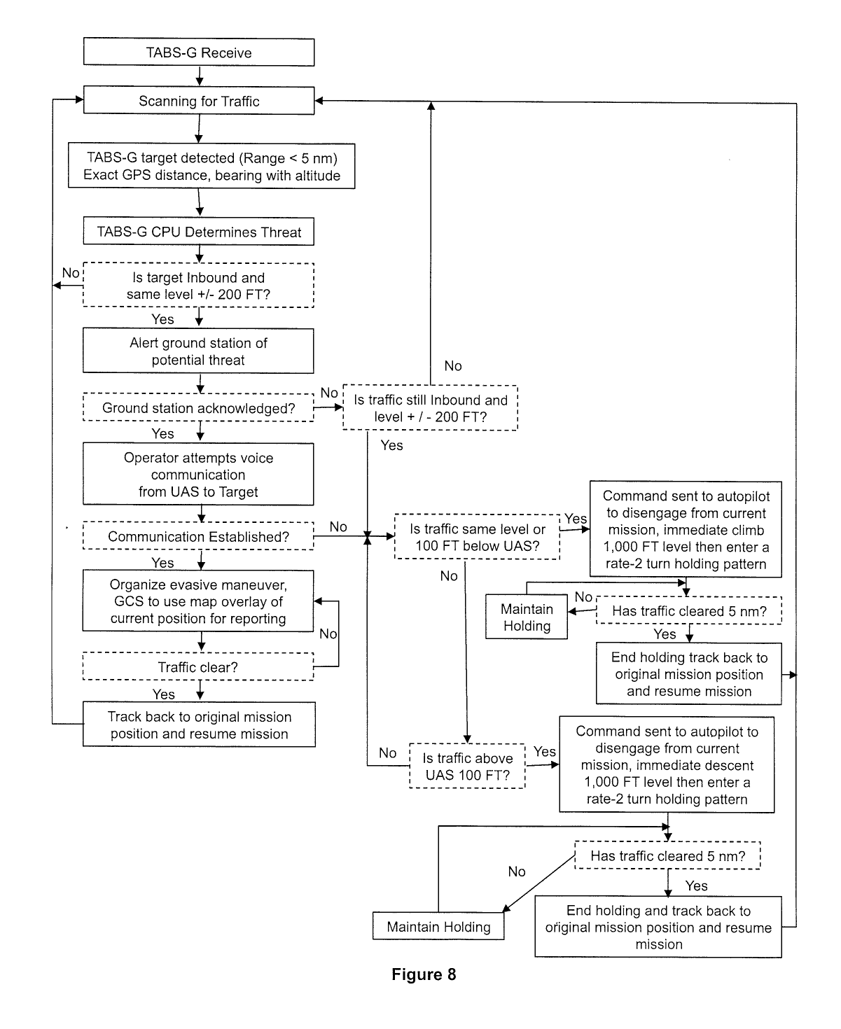

The systems of the present invention provide for two general means of avoiding collisions between the UAS and potential obstructions, namely, (1) the voice-enabled communications between the UAS (through the GCS) and third party aircraft (as described above); and (2) automatic collision avoidance maneuver protocols stored within and executed by the CPU and autopilot circuitry of the UAS. Referring now to FIGS. 6-8, diagrams are provided that summarize the processes by which the systems of the present invention detect (1) potential collision avoidance systems (PCAS) traffic (which consist of mode A/C/S replies, which are processed by a TABS-G core microprocessor to calculate nearest threat information based on altitude data generated from mode C and distance being calculated based on relative signal strength)(FIG. 6); (2) ADS-B/TABS traffic (which consist of DF17 or DF18 ADS-B/TABS broadcasts from other aircraft, which are processed by a TABS-G core microprocessor to calculate altitude based on ADS-B/TABS Baro data and location being calculated based on GPS data, along with velocity and bearing data)(FIG. 7); and (3) TABS-G traffic (FIG. 8), and then initiate the collision avoidance methods described herein.

As further illustrated in FIGS. 6-8, the CPU of the UAS will make an initial determination (based on detected inbound PCAS, ADS-B/TABS, and/or TABS-G information and data) whether an approaching obstruction (e.g., third party aircraft) represents a current collision threat. This determination may be made based on whether the approaching obstruction (e.g., third party aircraft) is within a pre-defined distance, such as within 200 feet (FT) from the UAS. If the approaching obstruction is outside of such pre-defined distance (which may be defined by a user of the system), then the approaching obstruction would not be considered a threat. Conversely, if the approaching obstruction is within such pre-defined distance, the approaching obstruction will be considered a potential collision threat, at which point the UAS will initiate contact with the GCS (as described above). The GCS operator(s) will then attempt to initiate voice communication (through the GCS and UAS) with the approaching obstruction, as described herein. If such communication links are established, the GCS operator(s) and the pilot of the approaching obstruction will organize collision avoidance maneuvers.

As further illustrated in FIGS. 6-8, if communication (through the GCS and UAS) with the approaching obstruction is not achieved, the CPU of the UAS will then execute a protocol to determine whether an automatic collision maneuver should be carried out. More specifically, the UAS will continue to monitor the location of the potential obstruction. If and when the potential obstruction is determined to be within a second defined distance from the UAS, e.g., if the potential obstruction is determined to be within 100 feet (FT) at approximately the same altitude (or within 100 FT below the UAS), the CPU will then instruct the autopilot circuitry to execute an automatic collision avoidance maneuver, such as an immediate climb of 1,000 FT above its then-current position. Similarly, if the potential obstruction is determined to be within 100 FT above the UAS, the CPU will then instruct the autopilot circuitry to execute an automatic collision avoidance maneuver, such as an immediate descent of 1,000 FT below its then-current position. Following these automatic collision maneuvers, the CPU will periodically determine whether the potential obstruction is still within a pre-defined space. If so, the UAS will either execute another collision avoidance maneuver or maintain a holding pattern a safe distance from the potential obstruction (if not, the UAS may end its holding pattern and resume its original flight path).

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for navigating an unmanned aircraft and avoiding collisions with airspace obstructions, which comprises:
(a) a surveillance system housed within an unmanned aircraft, wherein the surveillance system is configured to receive and broadcast (i) automatic dependent surveillance broadcasts (ADS-B), (ii) three-dimensional position information generated by a global positioning satellite (GPS) device along with a barometric sensor, and (iii) position information generated from a transponder that is configured to communicate in modes S, A, and C, wherein the surveillance system is configured to scan and detect obstructions within a defined area from the unmanned aircraft;
(b) a first central processing unit housed within the unmanned aircraft, which is configured to receive information from the surveillance system that identifies a location of an obstruction within the defined area, wherein the first central processing unit is further configured to determine whether an obstruction avoidance maneuver should be executed to avoid a collision with the obstruction; and
(c) flight control circuitry housed within the unmanned aircraft, which is configured to receive instructions from the first central processing unit and to direct the unmanned aircraft to execute the obstruction avoidance maneuver.

2. The system of claim 1, which further comprises a database housed within the unmanned aircraft that is configured to store and make accessible to the first central processing unit position information correlated to detected or known obstructions in the defined area.

3. The system of claim 2, wherein detected or known obstructions in the defined area consist of ground obstacles, airspace obstacles, and special exclusion zones.

4. The system of claim 3, which further comprises a ground control station that includes a second central processing unit, which is configured to communicate with the first central processing unit in the unmanned aircraft.

5. The system of claim 4, which further comprises a duplex digital voice system, which includes a first digital voice system housed within the unmanned aircraft and a second digital voice system housed within the ground control station, wherein the first digital voice system is configured to receive voice commands from the second digital voice system, which are then transmitted from the unmanned aircraft through an airband transceiver.

6. The system of claim 5, wherein the first digital voice system of the duplex digital voice system is further configured to receive incoming airband signals and to transmit the incoming airband signals to the second digital voice system in the ground control station.

7. The system of claim 6, wherein the position information correlated to detected or known obstructions represents three-dimensional global positioning satellite (GPS) coordinates.

8. The system of claim 7, wherein the position information correlated to detected or known obstructions may be provided to the database housed within the unmanned aircraft through a radio frequency (RF) communication link established by the ground control station.

9. The system of claim 8, wherein the ground control station further comprises a tracking antenna for an industrial-scientific-medical (ISM) band digital transceiver, whereby the tracking antenna is connected to and communicates with the second central processing unit, which receives automatic dependent surveillance broadcasts (ADS-B) from the unmanned aircraft to calculate a current location of the unmanned aircraft.

10. The system of claim 9, wherein the first digital voice system and second digital voice system each comprise a 16-bit coder-decoder (CODEC), which is configured to receive digital audio content and convert the digital audio content into analog content, and to receive an analog signal and convert the analog signal into digital audio content.

11. The system of claim 10, wherein after directing the unmanned aircraft to execute the obstruction avoidance maneuver, the first central processing unit is further configured to determine whether (a) a second obstruction avoidance maneuver should be executed to avoid a collision with the obstruction, (b) a holding flight pattern should be maintained, or (c) if an original flight pattern should be resumed.
